(19) United States
(12) Patent Application Publication
(10) Pub. No.: US 2025/0068836 A1
(43) Pub. Date: Feb. 27, 2025

(54) A TABLE DATA PROCESSING METHOD, APPARATUS, DEVICE AND MEDIUM

(71) Applicant: Beijing Zitiao Network Technology Co., Ltd., Beijing (CN)

(72) Inventors: Shuming TAN, Beijing (CN); Yanchun WU, Beijing (CN); Zhijie ZHENG, Beijing (CN)

(21) Appl. No.: 18/724,575

(22) PCT Filed: Dec. 12, 2022
(86) PCT No.: PCT/CN2022/138361

§ 371 Date: Jun. 26, 2024

(30) Foreign Application Priority Data
Dec. 29, 2021 (CN) 202111640146.9

(51) Int. Cl. G06F 40/18; G06T 11/00

(52) U.S. Cl. CPC G06F 40/18; G06T 11/001

(57) ABSTRACT

This application discloses a table data processing method. Sequence verification and a corresponding reference range can be set for any cell (first cell) in the table. The reference range can include one or more cells. After determining the reference range corresponding to the first cell, obtain the color corresponding to each cell in the reference range. Obtain the target data input by the user in the first cell, and determine whether the target data matches the data in the second cell in the reference range. If they match, the data in the first cell is changed based on the color corresponding to the second cell. Target data is rendered. The target data input in a cell complies with sequence verification, improving user experience.

This application claims priority of the Chinese patent application No. 202111640146.9, entitled “A tabular data processing method, device, equipment and medium” filed on Dec. 29, 2021, the entire content of which is incorporated herein by reference.

### FIELD

This application relates to computer field, and specifically to a table data processing method, apparatus, device and medium.

### BACKGROUND

A spreadsheet, also known as an electronic data table, is a cell composed of a series of rows and columns. The cell can store values, calculations, or text. Currently, the spreadsheet supports setting data validation on cells, so that data validation can add certain restrictions to the input data. For example, limit cells to only allow specific values to be input, etc. Wherein, sequence verification, as a subset of data verification, supports verification of the text of the cell. If the text of the cell is any item in the sequence, the verification passes.

In practical applications, sequence verification not only supports custom sequences, but also supports cell text in a predetermined range as a sequence by referencing it. For example, if the reference range of the sequence verification set for cell x is A1:A3, then the text allowed to be input in cell x is the text corresponding to each cell in A1, A2, and A3.

However, the current processing method of sequence verification is relatively simple. The data which passes the verification input by the user is rendered in the cell, which cannot improve the effect provided for the user and affects the user experience.

### SUMMARY

In view of this, this application provides a table data processing method, device, equipment and medium to render the corresponding color when the text of a cell passes verification, thereby improving intuitiveness and user experience.

In order to achieve the above purpose, the technical solutions provided by this application are as follows:

In the first aspect of this application, a table data processing method is provided, the method including:
In response to a setting operation triggered by the user, obtaining a reference range corresponding to the sequence verification set for the first cell, the reference range including one or more cells;
Obtain the color corresponding to each cell in the reference range;
In response to an input operation triggered by the user, obtaining the target data input by the user in the first cell;
In response to the target data matching the data in the second cell in the reference range, the target data in the first cell is rendered according to the color corresponding to the second cell, and the second cell is any cell in the reference range.

In the second aspect of this application, a table data processing apparatus is provided, and the apparatus includes:
The first obtaining unit is used to obtain the reference range corresponding to the sequence verification set for the first cell in response to a setting operation triggered by a user, and the reference range includes one or more cells;
The second obtaining unit is used to obtain the color corresponding to each cell in the reference range;
The third obtaining unit is used to obtain the target data input by the user in the first cell in response to the input operation triggered by the user;
A rendering unit used to render the target data in the first cell according to the color corresponding to the second cell in response to the target data matching data in the second cell in the reference range, the second cell being any cell in the reference range.

In a third aspect of the present application, an electronic device is provided, the device including: a processor and a memory;
The memory is used to store instructions or computer programs;
The processor is used to execute the instructions or computer programs in the memory, such that the electronic device executes the table data processing method.

In a fourth aspect of the present application, a computer-readable storage medium is provided. Instructions are stored in the computer-readable storage medium. In response to the instructions being run on a device, the device is caused to perform the table data processing. method.

In a fifth aspect of the present application, a computer program product is provided. The computer program product includes a computer program. In response to the computer program being executed by a processor, it causes the processor to implement the table data processing method described above.

It can be seen that the embodiments of this application have the following beneficial effects:

In this application, for any cell (the first cell) in the table, the sequence verification in the data verification and the reference range corresponding to the sequence verification can be set, and the reference range can include one or more cells. After determining the reference range corresponding to the first cell, obtain the color corresponding to each cell in the reference range. Obtain the target data input by the user in the first cell, and determine whether the target data matches the data in the second cell in the reference range. If they match, the data in the first cell is rendered based on the color corresponding to the second cell. Wherein, the second cell is any cell in the reference range. That is, when the target data input in the first cell matches the data of a certain cell in the reference range, the target data is rendered using the color corresponding to the cell, so that the user can intuitively know that the target data input in the first cell complies with sequence verification, improving user experience.

### BRIEF DESCRIPTION OF THE DRAWINGS

In order to more clearly illustrate the embodiments of the present application or the technical solutions in the prior art, the drawings needed to be used in the description of the embodiments or the prior art will be briefly introduced below. Obviously, the drawings in the following description are only for the purpose of describing the embodiments or the prior art. For some of the embodiments recorded in the application, those of ordinary skill in the art can also obtain other drawings based on these drawings without exerting creative efforts.

FIG. 1 is a flow chart of a client skin processing method provided by embodiments of this application;

FIG. 2a is a schematic diagram of a page for setting sequence verification provided by embodiments of this application;

FIG. 2b is a schematic diagram of a scenario for determining the reference range provided by embodiments of this application;

FIG. 2c is a schematic diagram of a reference scenario provided by embodiments in this application;

FIG. 2d is a schematic diagram of another application scenario provided by embodiments of this application;

FIG. 2e is a schematic diagram of an editing option color provided by embodiments in this application;

FIG. 3a is a schematic diagram of a rendering effect provided by the embodiments of this application;

FIG. 3b is a schematic diagram of another rendering effect provided by the embodiments of this application;

FIG. 3c is a schematic diagram of a display option provided by the embodiments of this application;

FIG. 4 is a schematic structural diagram of a device provided by embodiments of this application;

FIG. 5 is a schematic structural diagram of an electronic device provided by embodiments of this application.

### DETAILED DESCRIPTION

In order to enable the personnel of this field to better understand the solution of this application, the technical solutions in the embodiments of this application will be clearly and completely described below in conjunction with the drawings in the embodiments of this application. Obviously, the described embodiments are only a part of this application. embodiments, not all embodiments. Based on the embodiments in this application, all other embodiments obtained by those of ordinary skill in the art without creative efforts fall in the scope of protection of this application.

Sequence verification is a verification method of data verification. It supports the verification of the data input in the cell. When the data input in the cell is any item of the specified sequence, the verification is passed and the input data is displayed in the cell. Otherwise, the data input by the user is illegal. The current method of sequence verification to reflect the verification results is relatively simple. When the verification is passed, the data is displayed in the cell, which cannot give users an intuitive feeling and affects the user experience.

Based on this, the embodiments of this application provide a table data processing method. When performing sequence verification on the data input in the first cell in the table, if the data input in the first cell belongs to the corresponding reference range of the sequence verification When the data is limited to a certain cell, the color corresponding to the cell is used to render the data in the first cell, thereby enhancing the rendering effect of the first cell, making it easier for the user to view, and improving the user experience.

In order to facilitate understanding of the technical solution provided by the embodiments of this application, the following will be described in conjunction with the accompanying drawings.

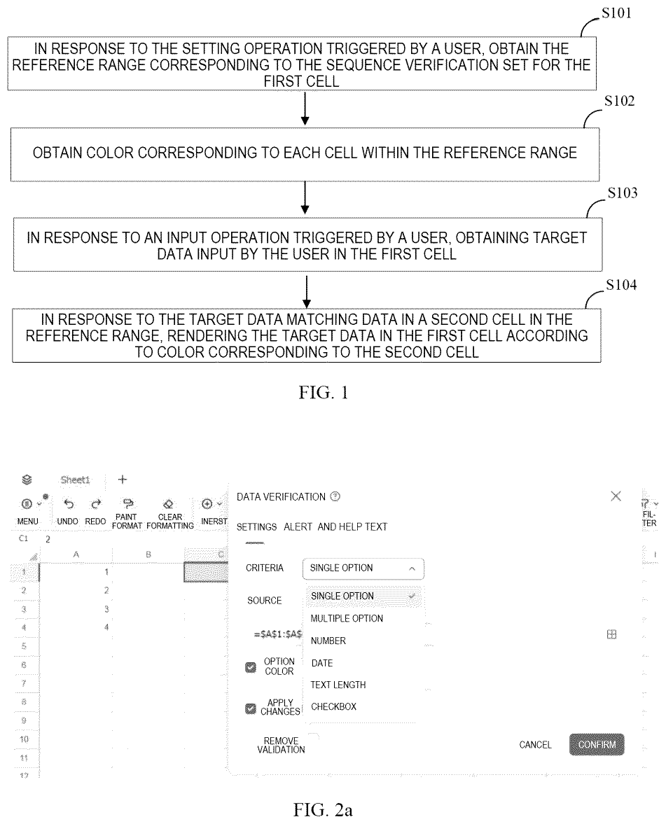

Refer to FIG. 1, which is a flow chart of a form data processing method provided by embodiments of this application. As shown in FIG. 1, the method may include:

S101: In response to the setting operation triggered by the user, obtain the reference range corresponding to the sequence verification set for the first cell.

In this embodiment, users can set sequence verification for the first cell in the table, and then obtain the reference range corresponding to the sequence verification. The reference range can include one or more cells. Among them, the selection area corresponding to the reference range can be divided into the following situations: general selection area, row selection area and column selection area. The general selection area refers to the corresponding starting row or column and ending row or column, and the expression is [number of columns] [number of rows]: [number of columns] [Number of rows], for example, the selection area corresponding to the reference range is A1:B3; the row selection area refers to the selection area corresponding to the starting row and the ending row. The number of columns is equal to the number of columns of the table, and the expression is [Number of rows]: [Number of rows], for example, the selection area corresponding to the reference range is 3:6, that is, all columns between row 3 and row 6; the column selection area refers to the corresponding starting column and ending column, and the number of rows is equal to the number of rows in the table, for example The selection area corresponding to the reference range is C:E, that is, all rows between columns C and E.

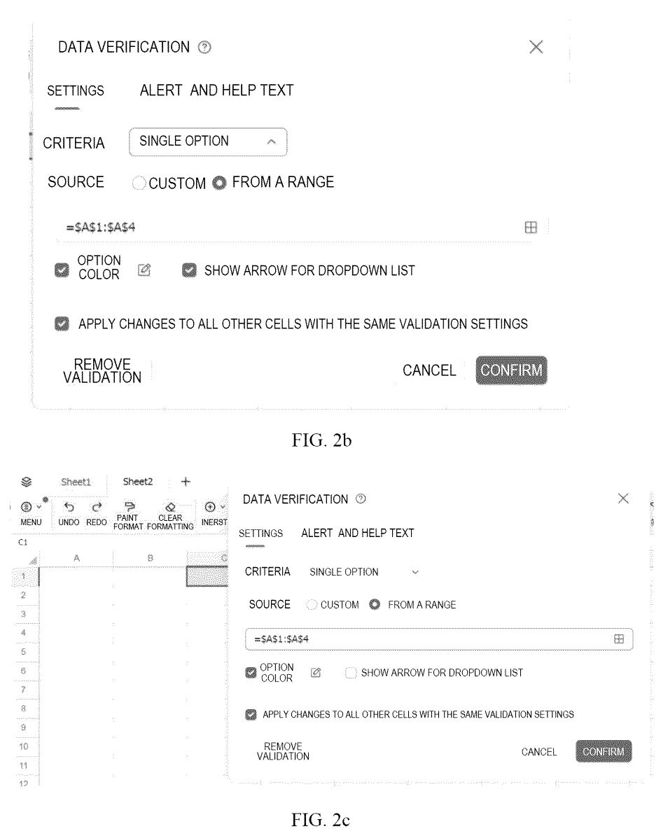

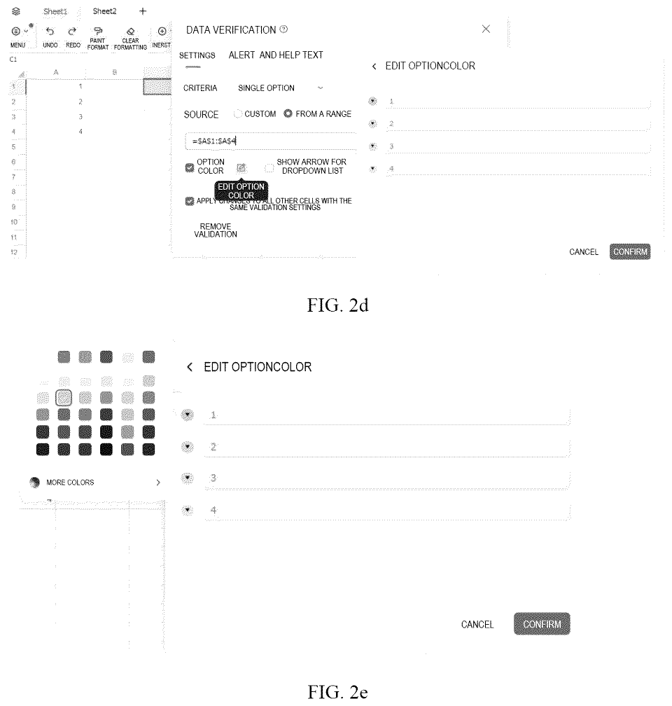

As shown in FIG. 2a, for cell C1 in the table, right-click to enter the data verification page, where you can select verification conditions. Wherein, you can choose single-choice or multiple-choice for the verification conditions of sequence verification. single-choice means that the set cell C1 (the first cell) is allowed to input a single data, and multiple-choice means that the set cell C1 is allowed to input a plurality of data. After determining the verification conditions, select the reference data in “Option Source” to set the reference range. As shown in FIG. 2b, the verification condition is “single-choice” and the reference range of the reference data is A1: A4.

S102: Obtaining the color corresponding to each cell in the reference range.

After determining the reference range corresponding to the first cell, obtain the color corresponding to each cell in the reference range, that is, the color of the option corresponding to each cell. Wherein, each cell in the reference range corresponds to an option, so that the first cell can reference the option.

Specifically, the color corresponding to each cell in the reference range can be obtained in the following two ways. One is, in response to any data failing to be input into the cells in the reference range, that is, there are no options for the cells in the reference range, then determining the color corresponding to each cell in the reference range according to the predetermined color configuration rule. For example, randomly configure a color for each cell in the reference range. For example, as shown in FIG. 2c, the reference range set for cell C1 is A1: A4, but there is currently no data option for A1: A4. After the user selects the “Option Color” control, the system automatically configures different colors for the 4 cells in A1-A4.

The other is to determine the color set by the user for each cell in the reference range in response to data being input into the cells in the reference range and a user-triggered set operation. That is, if there are options in the cells in the reference range, the user can set the color corresponding to the options in each cell by themself. Specifically, if there are options in cells in the reference range, the system can also pre-configure the color for each option in the reference range. On this basis, the user can modify the color of each option in the reference range by themself. For example, as shown in FIG. 2d, the reference range set in cell C1 is A1: A4 and the options for A1-A4 are 1-4 respectively. The user can enter the page for editing option colors by clicking the option color editing control on the data verification page. On this page, the page displays the colors configured for each option by the system. For example, option 1 is blue, option 2 is red, option 3 is green, and option 4 is yellow. The user can configure the color for an option through the color palette by clicking on the drop-down control located before the option to display the color palette. For example, as shown in FIG. 2e, the color palette is displayed by triggering the drop-down control of option 1.

S103: In response to the input operation triggered by the user, obtain the target data input by the user in the first cell.

S104: In response to the target data matching the data in the second cell in the reference range, render the target data in the first cell according to the color corresponding to the second cell.

In this embodiment, after setting the reference range of the sequence verification corresponding to the first cell, the user can input the target data in the first cell. The target data may be data in the reference range, or it may not be data in the reference range. Further, the user can input one target data in the first cell, such as if the verification condition is single-choice, or a plurality of target data can be input in the first cell, if the verification condition is multiple-choice. For each target data input by the user in the first cell, the target data will be verified based on the data of each cell in the predetermined reference range. If the target data is in consistent with the data in a certain cell (the second cell) in the reference range, the target data in the first cell is rendered according to the color corresponding to the cell.

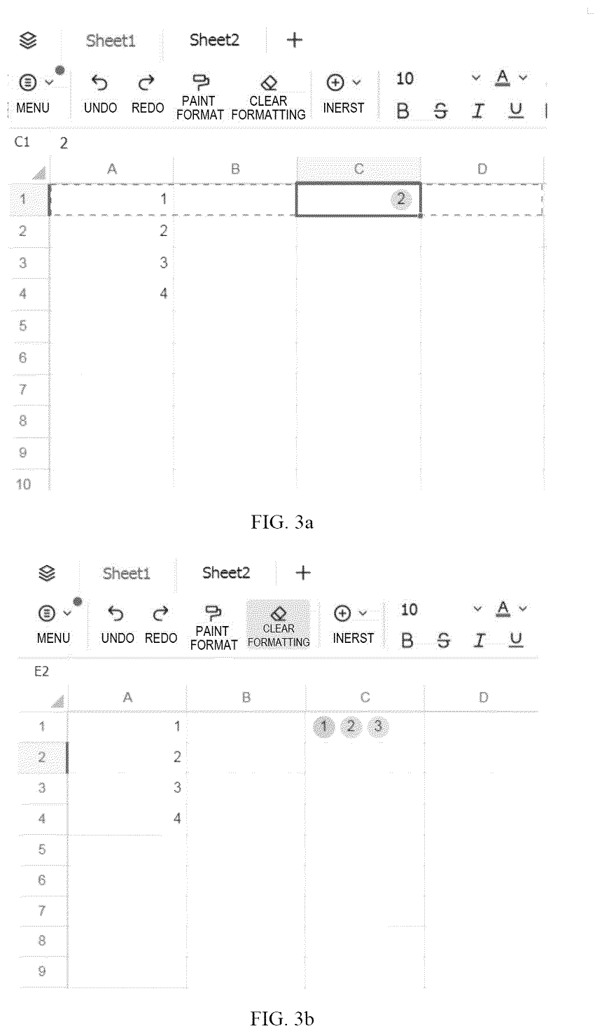

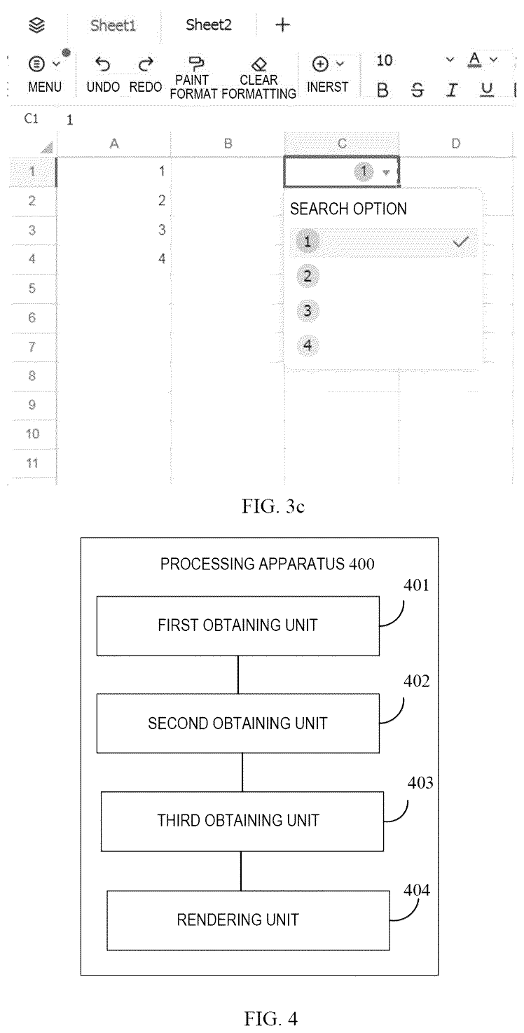

Optionally, in response to the target data matching the data in the second cell in the reference range, the target data is rendered according to the color corresponding to the second cell and the predetermined rendering mode. Wherein, the rendering mode is used to indicate the presentation form of the target data in the first cell. For example, the rendering mode may include wrapping the target data with a capsule, the color of the capsule being the color corresponding to the second table. Of course, other rendering modes are also possible, which are not limited in this application. For example, as shown in FIG. 3a, the user input target data 2 in the cell C1 option, and it is determined through sequence verification that it matches the data 2 in cell A2 in the reference range, then the capsule package data 2 is rendered in cell C1, and the capsule's color is in consistent with the color corresponding to data 2 in A2.

It should be noted that in actual applications, after configuring colors for the options of each cell in the predetermined range, only if the option of the cell in the reference range is referenced, the color of the option of the referenced cell will be displayed in the first cell. The color of the option is usually not displayed in the original cell. For example, in FIG. 3a, the color of the A2 option is displayed through a capsule, and its corresponding color is not displayed in the A2 cell.

As another example shown in FIG. 3b, if the verification condition corresponding to cell C1 is multiple-choice, it is able to input a plurality of target data 1, 2, and 3 in C1, through verification, determining that the target data 1 matching the data in A1, the target data 2 matching the data in A2, the target data 3 matching the data in A3, then performing rendering in C1 respectively. The color of the capsule wrapping target data 1 is the color corresponding to A1. The color of the capsule wrapping target data 2 is the color corresponding to A2. The color of the capsule wrapping target data 3 is the color corresponding to A3.

Optionally, in response to the user inputting the target data in the first cell, the user may enter the target data manually or select the data to be input through the drop-down mode. Specifically, upon setting the reference range of the sequence verification of the first cell, if “Show drop-down control” is selected, the drop-down control will be displayed in the first cell. By clicking the drop-down control, the user may view the data corresponding of each cell in the reference range. For example, as shown in FIG. 2b and FIG. 3c, if “Show drop-down arrow” is selected, the drop-down arrow will be displayed in cell C1. Through the drop-down arrow, the data 1-4 in the reference range can be viewed, and the user can select from it. As shown in FIG. 3c, the options viewed through the drop-down arrow have been rendered based on the color of the cell. After the user selects any of the options, the option can be displayed directly in C1.

Optionally, if the user views the options that are allowed to be input through the drop-down control, the user can also use the search control on the options page to search for the option that the user wants to input. If the option the user wants to input belongs to the reference range, the option will be displayed directly; if the option the user wants to enter fails to be in the reference range, the user will be notified that the option being searched for is missing.

It can be seen that for any cell (the first cell) in the table, the sequence verification in the data verification and the reference range corresponding to the sequence verification can be set, and the reference range can include one or more cells. After determining the reference range corresponding to the first cell, obtain the color corresponding to each cell in the reference range. Obtain the target data input by the user in the first cell, and determine whether the target data matches the data in the second cell in the reference range. If they match, the target data in the first cell is rendered based on the color corresponding to the second cell. Wherein, the second cell is any cell in the reference range. That is, if the target data input in the first cell matches the data in a certain cell in the reference range, the target data is rendered using the color corresponding to the cell, such that the user can intuitively know that the target data input in the first cell complies with sequence verification through the color, improving user experience.

Optionally, in the present embodiment, upon configuring colors for cells in the reference range, the data structure corresponding to the colors of the cells in the reference range can be an array, such as a one-dimensional array or a two-dimensional array. Wherein, the position of the color corresponding to the second cell in the array is determined by the second cell and the upper-left corner cell in the reference range. That is, the position of the corresponding color of the second cell in the array is determined by the relative position of the second cell and the upper-left corner cell in the reference range.

Specifically, the array row identification of the corresponding color of the second cell is the difference between the row number of the second cell and the row number of the third table, and the array column identification is the difference between the column number of the second table and the column number of the third table, the third table is the upper left corner cell in the reference range. For example, the reference range is B2: C4, then the color corresponding to C4 is color [2] [1], where 2=4−2, 1=C−B=2-1, and the color corresponding to B2 is color [0] [0].

It should be noted that in this embodiment, the relative position is used to determine the position of the color of the color. If the size of the reference range changes, the color of the cells in the reference range can be adjusted efficiently and as little as possible. Specifically, in response to a change in the size of the reference range, the colors corresponding to the cells in the reference range are adjusted in batches. Wherein, the change in the size of the reference range refers to the adding or deleting of rows in the reference range, causing the size of the reference range to change. For example, if the cell color is a two-dimensional array, the reference range size is n rows and m columns, and the i-th row is deleted, you only need to move the colors of n-i rows forward.

Optional, if the position of the reference range changes, such as cutting and pasting, dragging, adding or deleting rows outside the reference range, etc., since the position of the color of the cell is the position relative to the upper left corner cell of the reference range, if the position of the reference range changes, it will not cause the position of the color of the cell to change, so there is no need to adjust the color of the cell.

Wherein, changes in the size of the reference range can include changes in the size of general selection area, changes in the size of row selection area, and changes in the size of column selection area. Specifically, changes in the size of the general selection area include adding or deleting rows and columns in the general selection area. Changes in the size of the row selection area may include modifying the number of rows in the row selection area and changes in the number of columns in the sub-table where the row selection area is located. Wherein, changes in the number of columns in the sub-table where the row selection is located may include: adding or deleting columns in the sub-table where the row selection area is located and the sub-table where the row selection area is located changes, and the number of columns of the changed sub-table and the number of columns of the original sub-table are different. Changes in the size of the column selection area can include modifying the number of columns in the column selection area and changes in the number of rows in the sub-table where the column selection area is located. Changes in the number of rows in the sub-table where the column selection area is located can include: adding or deleting rows in the sub-table where the column selection area is located and the sub-table where the column selection area is located changes, and the number of rows in the changed sub-table and the number of rows in the original table are different.

Based on the above method embodiments, this application embodiment provides a table data processing device, which will be described below with reference to the accompanying drawings.

Referring to FIG. 4, this figure is a structural diagram of a table data processing apparatus provided by embodiments of the present application. As shown in FIG. 4, the apparatus 400 may include: a first obtaining unit 401, a second obtaining unit 402, and a third obtaining unit 403 and rendering unit 404.

A first obtaining unit 401 is used to respond to a setting operation triggered by a user, obtaining a reference range corresponding to a sequence verification set for a first cell, the reference range comprising one or more cells;

a second obtaining unit 402 is used to obtain color corresponding to each cell in the reference range;

a third obtaining unit 403 is used to respond to an input operation triggered by a user, obtaining target data input by the user in the first cell;

a rendering unit 404 is used to respond to the target data matching data in a second cell in the reference range, rendering the target data in the first cell according to color corresponding to the second cell, the second cell being any cell in the reference range.

In a specific implementation, the rendering unit 404 is specifically configured to respond to the target data matching the data in the second cell in the reference range, rendering the target data according to the color corresponding to the second cell and the predetermined rendering mode, the rendering mode being used to indicate a presentation form of the target data in the first cell.

In a specific implementation, the rendering mode comprises wrapping the target data with a capsule, a color of the capsule being the color corresponding to the second table.

In a specific implementation, the second obtaining unit 402 is specifically configured to determine a color corresponding to each cell in the reference range according to a predetermined color configuration rule, in response to any data failing to be input into a cell in the reference range; in response to data having been input into a cell in the reference range and a setting operation triggered by the user, determines a color set by the user for each cell in the reference range.

In a specific implementation, a data structure of corresponding a color of a cell in the reference range is an array.

In a specific implementation, a position of corresponding color of the second cell in the array is determined by the second cell and an upper left corner cell in the reference range.

In a specific implementation, an array row identification of a corresponding color of the second cell is a difference between a row number of the second table and a row number of a third table, an array column identification being a difference between a column number of the second table and a column number of the third table, the third table being an upper left corner cell in the reference range.

In a specific implementation manner, a selection area corresponding to the reference range is a general selection area, a row selection area or a column selection area, the general selection area referring to a selection area corresponding to a starting row or column and an ending row or column, the row selection area referring to a selection area corresponding to a starting row and an ending row, the column selection area referring to a selection area corresponding to a starting column and an ending column.

In a specific implementation, a change in a size of the reference range refers to adding or deleting row or column in the general selection area, a change in a number of rows in the row selection area or a change in a number of columns of a sub-table where the row selection area is located, a change in a number of columns of the column selection area or a change in a number of rows of a sub-table where the column selection area is located.

In a specific implementation, the apparatus further includes: an adjustment unit;

The adjustment unit is specifically configured to adjust the colors corresponding to the cells in the reference range in batches in response to changes in the size of the reference range.

In a specific implementation, a verification condition of the sequence verification comprises single-choice and multiple-choice, the single-choice being used to indicate allowing to input a single data in the first cell, the multiple-choice being used to indicate allowing to input a plurality of data in the first cell.

It should be noted that the implementation of each unit in this embodiment can be found in the relevant descriptions in the above method embodiments, and this embodiment will not be repeated here.

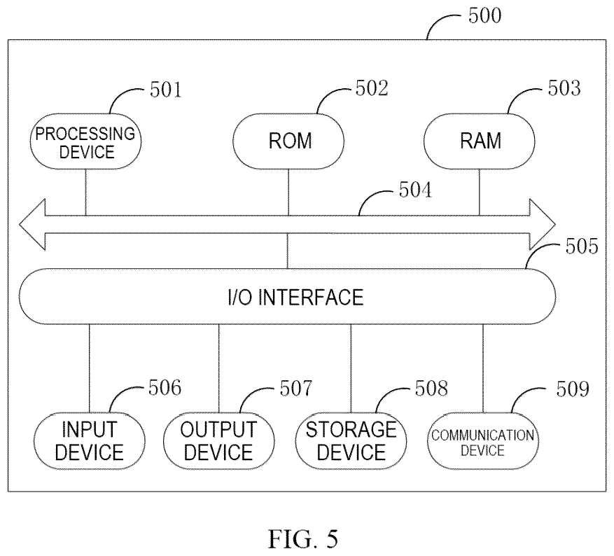

Referring to FIG. 5, a schematic structural diagram of an electronic device 500 suitable for implementing embodiments of the present application is shown. Electronic devices in the embodiments of this application may include, but are not limited to, mobile phones, laptops, digital broadcast receivers, PDA (Personal Digital Assistant, personal digital assistant), PAD (portable android device, tablet computer), PMP (Portable Media Player, portable multimedia players), vehicle-mounted terminals (such as vehicle-mounted navigation terminals), etc., as well as fixed terminals such as digital TV (television, television), desktop computers, etc. The electronic device shown in FIG. 5 is only an example, and should not bring any limitations to the functions and scope of use of the embodiments of this application.

As shown in FIG. 5, the electronic device 500 may include a processing device (e.g. central processing unit, graphics processor, etc.) 501, which may be loaded into a random access memory (RAM) 503 according to a program stored in a read-only memory (ROM) 502 or from a storage device 508. The program in the memory (RAM) 503 executes various appropriate actions and processes. In the RAM 503, various programs and data required for the operation of the electronic device 500 are also stored. The processing device 501, the ROM 502 and the RAM 503 are connected to each other via a bus 504. An input/output (I/O) interface 505 is also connected to bus 504.

Generally, the following apparatus may be connected to the I/O interface 505: input devices 506 including, for example, a touch screen, touch pad, keyboard, mouse, camera, microphone, accelerometer, gyroscope, etc.: output device 507 including, for example, a liquid crystal display (LCD), speaker, vibration: a storage device 508 including a magnetic tape, a hard disk, etc.; and a communication device 509. Communication device 509 may allow electronic device 500 to communicate wirelessly or wiredly with other devices to exchange data. Although FIG. 5 illustrates electronic device 500 with various means, it should be understood that implementation or availability of all illustrated means is not required. More or fewer means may alternatively be implemented or provided.

In particular, according to embodiments of the present application, the processes described above with reference to the flowcharts may be implemented as computer software programs. For example, embodiments of the present application include a computer program product, which includes a computer program carried on a non-transitory computer-readable medium, and the computer program includes program code for executing the method shown in the flowchart. In such embodiments, the computer program may be downloaded and installed from the network via the communication device 509, or installed from the storage device 508, or from the ROM 502. When the computer program is executed by the processing device 501, the above-mentioned functions defined in the method of embodiments of the present application are executed.

The electronic device provided by the embodiments of this application and the table data processing method provided by the above-mentioned embodiments belong to the same inventive concept. Technical details not described in detail in this embodiment can be found in the above-mentioned embodiments, and this embodiment has the same beneficial effects as the above-mentioned embodiments.

The embodiments of this application provide a computer-readable medium on which a computer program is stored. When the program is executed by a processor, the form data processing method described in any of the above embodiments is implemented.

It should be noted that the computer-readable medium mentioned above in this application may be a computer-readable signal medium or a computer-readable storage medium, or any combination of the above two. The computer-readable storage medium may be, for example, but not limited to, an electrical, magnetic, optical, electromagnetic, infrared, or semiconductor system, device or apparatus, or any combination thereof. More specific examples of computer readable storage media may include, but are not limited to: an electrical connection having one or more wires, a portable computer disk, a hard drive, random access memory (RAM), read only memory (ROM), erasable memory programmable read-only memory (EPROM or flash memory), optical fiber, portable compact disk read-only memory (CD-ROM), optical storage device, magnetic storage device, or any suitable combination of the above. As used herein, a computer-readable storage medium may be any tangible medium that contains or stores a program for use by or in connection with an instruction execution system, apparatus, or device. In this application, the computer-readable signal medium may include a data signal propagated in baseband or as part of a carrier wave, in which computer-readable program code is carried. Such propagated data signals may take many forms, including but not limited to electromagnetic signals, optical signals, or any suitable combination of the above. A computer-readable signal medium may also be any computer-readable medium other than a computer-readable storage medium that can send, propagate, or transmit a program for use by or in connection with an instruction execution system, apparatus, or device. Program code embodied on a computer-readable medium may be transmitted using any suitable medium, including but not limited to: wire, optical fiber cable, RF (radio frequency), etc., or any suitable combination of the foregoing.

In some embodiments, the client and server can communicate using any currently known or future developed network protocol such as HTTP (HyperText Transfer Protocol), and can communicably (e.g. communication networks) interconnect with digital data in any form or medium. Examples of communications networks include local area networks (“LAN”), wide area networks (“WAN”), the Internet (e.g., the Internet), and end-to-end networks (e.g., ad hoc end-to-end networks), as well as any currently known or future developed network.

The above-mentioned computer-readable medium may be included in the above-mentioned electronic device: it may also exist independently without being assembled into the electronic device.

The computer-readable medium carries one or more programs. When the one or more programs are executed by the electronic device, the electronic device executes the table data processing method.

Computer program code for performing the operations of the present application may be written in one or more programming languages, including, but not limited to, object-oriented programming languages-such as Java, Smalltalk, C++, and Includes conventional procedural programming languages-such as “C” or similar programming languages. The program code may execute entirely on the user's computer, partly on the user's computer, as a stand-alone software package, partly on the user's computer and partly on a remote computer or entirely on the remote computer or server. In situations involving remote computers, the remote computer can be connected to the user's computer through any kind of network, including a local area network (LAN) or a wide area network (WAN), or it can be connected to an external computer (such as an Internet service provider through Internet connection).

The flowcharts and block diagrams in the accompanying drawings illustrate the possible architecture, functions and operations of the systems, methods and computer program products according to the various embodiments of the present application. In this regard, each block in the flowchart or block diagram may represent a module, segment, or portion of code that contains one or more logic functions that implement the specified executable instructions. It should also be noted that, in some alternative implementations, the functions noted in the block may occur out of the order noted in the figures. For example, two blocks shown one after another may actually execute substantially in parallel, or they may sometimes execute in the reverse order, depending on the functionality involved. It will also be noted that each block of the block diagram and/or flowchart illustration, and combinations of blocks in the block diagram and/or flowchart illustration, can be implemented by special purpose hardware-based systems that perform the specified functions or operations, or can be implemented using a combination of specialized hardware and computer instructions.

The units involved in the embodiments described in this application can be implemented in software or hardware. Among them, the name of the unit/module does not constitute a limitation on the unit itself under certain circumstances. For example, the voice data collection module can also be described as a “data collection module”.

The functions described above herein may be performed, at least in part, by one or more hardware logic components. For example, and without limitation, exemplary types of hardware logic components that may be used include: Field Programmable Gate Arrays (FPGA). Application Specific Integrated Circuits (ASIC), Application Specific Standard Products (ASSP), Systems on Chips (SOC), Complex Programmable Logical device (CPLD) and so on.

In the context of this application, a machine-readable medium may be a tangible medium that may contain or store a program for use by or in connection with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, devices or devices, or any suitable combination of the foregoing. More specific examples of machine-readable storage media would include one or more wires based electrical connection, laptop disk, hard drive, random access memory (RAM), read only memory (ROM), erasable programmable read only memory (EPROM or flash memory), optical fiber, portable compact disk read-only memory (CD-ROM), optical storage device, magnetic storage device, or any suitable combination of the above.

It should be noted that each embodiment is described in a progressive manner in this manual. Each embodiment focuses on its differences from other embodiments. The same and similar parts between each embodiment can be referred to each other. For the system or device disclosed by embodiments, since it corresponds to the method disclosed by embodiments, the description is relatively simple. For relevant details, please refer to the description of the method section.

It should be understood that in this application, “at least one (item)” refers to one or more, and “plurality” refers to two or more. “And/or” is used to describe the relationship between associated objects, indicating that there can be three relationships. For example, “A and/or B” can mean: only A exists, only B exists, and A and B exist simultaneously, where A and B can be singular or plural. The character “/” generally indicates that the related objects are in an “or” relationship. “At least one of the following” or similar expressions thereof refers to any combination of these items, including any combination of a single item (items) or a plurality of items (items). For example, at least one item (item) of a, b or c can mean: a, b, c, “a and b”. “a and c”, “b and c”, or “a and b and c”, where a, b, c can be single or plural.

It should also be noted that in this article, relational terms such as first and second are only used to distinguish one entity or operation from another entity or operation, and do not necessarily require or imply that these entities or operations have actual relationship or sequence between them. Furthermore, the terms “comprises,” “include,” or any other variation thereof are intended to cover a non-exclusive inclusion such that a process, method, article, or apparatus that includes a list of elements includes not only those elements, but also those not expressly listed other elements, or elements inherent to the process, method, article or equipment. Without further limitation, an element defined by the statement “comprises a . . . ” does not exclude the presence of additional identical elements in a process, method, article, or apparatus that includes the stated element.

The steps of the methods or algorithms described in conjunction with the embodiments disclosed herein may be implemented directly in hardware, in software modules executed by a processor, or in a combination of the two. Software modules may be located in random access memory (RAM), memory; read-only memory (ROM), electrically programmable ROM, electrically erasable programmable ROM, registers, hard disks, removable disks, CD-ROMs, or fields as they are known. any other form of storage media.

The above description of the disclosed embodiments enables those skilled in the art to implement or use the present application. Various modifications to these embodiments will be apparent to those skilled in the art, and the general principles defined herein may be implemented in other embodiments without departing from the spirit or scope of the application. Therefore, the present application is not to be limited to the embodiments shown herein but is to be accorded the widest scope consistent with the principles and novel features disclosed herein.

1-15. (canceled)

16. A table data processing method, wherein the method comprises:
in response to a setting operation triggered by a user, obtaining a reference range corresponding to a sequence verification set for a first cell, the reference range comprising one or more cells;
obtaining a color corresponding to each cell in the reference range;
in response to an input operation triggered by the user, obtaining target data input by the user in the first cell;
in response to the target data matching data in a second cell in the reference range, rendering the target data in the first cell according to a color corresponding to the second cell, the second cell being any cell in the reference range.

17. The method of claim 16, wherein in response to the target data matching data in a second cell in the reference range, rendering the target data in the first cell according to color corresponding to the second cell, comprises:
in response to the target data matching data in a second cell in the reference range, rendering the target data according to a color corresponding to the second cell and a predetermined rendering mode, the rendering mode being used to indicate a presentation form of the target data in the first cell.

18. The method of claim 17, wherein the rendering mode comprises wrapping the target data with a capsule, a color of the capsule being the color corresponding to the second cell.

19. The method of claim 16, wherein obtaining color corresponding to each cell in the reference range comprises:
in response to any data failing to be input into a cell in the reference range, determining a color corresponding to each cell in the reference range according to a predetermined color configuration rule;
in response to data having been input into a cell in the reference range and a setting operation triggered by the user, determining a color set by the user for each cell in the reference range.

20. The method of claim 16, wherein a data structure of corresponding a color of a cell in the reference range is an array.

21. The method of claim 20, wherein a position of corresponding color of the second cell in the array is determined by the second cell and an upper left corner cell in the reference range.

22. The method of claim 21, wherein an array row identification of a corresponding color of the second cell is a difference between a row number of the second cell and a row number of a third cell, an array column identification being a difference between a column number of the second cell and a column number of the third cell, the third cell being an upper left corner cell in the reference range.

23. The method of claim 16, wherein a selection area corresponding to the reference range is a general selection area, a row selection area or a column selection area, the general selection area referring to a selection area corresponding to a starting row or column and an ending row or column, the row selection area referring to a selection area corresponding to a starting row and an ending row, the column selection area referring to a selection area corresponding to a starting column and an ending column.

24. The method of claim 23, wherein a change in a size of the reference range refers to adding or deleting row or column in the general selection area, a change in a number of rows in the row selection area or a change in a number of columns of a sub-table where the row selection area is located, a change in a number of columns of the column selection area or a change in a number of rows of a sub-table where the column selection area is located.

25. The method of claim 24, wherein the method further comprises:
in response to a change in a size of the reference range, adjusting color corresponding to cell in the reference range in batch.

26. The method of claim 16, wherein a verification condition of the sequence verification comprises single-choice and multiple-choice, the single-choice being used to indicate allowing to input a single data in the first cell, the multiple-choice being used to indicate allowing to input a plurality of data in the first cell.

27. An electronic device, wherein the device comprises:
a processor and a memory;
the memory, used to store instruction or computer program;
the processor, used to execute the instruction or computer program in the memory, such that the electronic device executes a table data processing method comprising:
in response to a setting operation triggered by a user, obtaining a reference range corresponding to a sequence verification set for a first cell, the reference range comprising one or more cells;
obtaining a color corresponding to each cell in the reference range;
in response to an input operation triggered by the user, obtaining target data input by the user in the first cell;
in response to the target data matching data in a second cell in the reference range, rendering the target data in the first cell according to a color corresponding to the second cell, the second cell being any cell in the reference range.

28. The electronic device of claim 27, wherein in response to the target data matching data in a second cell in the reference range, rendering the target data in the first cell according to color corresponding to the second cell, comprises:
in response to the target data matching data in a second cell in the reference range, rendering the target data according to a color corresponding to the second cell and a predetermined rendering mode, the rendering mode being used to indicate a presentation form of the target data in the first cell.

29. The electronic device of claim 28, wherein the rendering mode comprises wrapping the target data with a capsule, a color of the capsule being the color corresponding to the second cell.

30. The electronic device of claim 27, wherein obtaining color corresponding to each cell in the reference range comprises:
in response to any data failing to be input into a cell in the reference range, determining a color corresponding to each cell in the reference range according to a predetermined color configuration rule;
in response to data having been input into a cell in the reference range and a setting operation triggered by the user, determining a color set by the user for each cell in the reference range.

31. The electronic device of claim 27, wherein a data structure of corresponding a color of a cell in the reference range is an array.

32. The electronic device of claim 31, wherein a position of corresponding color of the second cell in the array is determined by the second cell and an upper left corner cell in the reference range.

33. The electronic device of claim 32, wherein an array row identification of a corresponding color of the second cell is a difference between a row number of the second cell and a row number of a third cell, an array column identification being a difference between a column number of the second cell and a column number of the third cell, the third cell being an upper left corner cell in the reference range.

34. The electronic device of claim 27, wherein a selection area corresponding to the reference range is a general selection area, a row selection area or a column selection area, the general selection area referring to a selection area corresponding to a starting row or column and an ending row or column, the row selection area referring to a selection area corresponding to a starting row and an ending row, the column selection area referring to a selection area corresponding to a starting column and an ending column.

35. A non-transitory computer-readable storage medium, wherein instruction is stored thereon, in response to the instruction being run on a device, causing the device to execute a table data processing method comprising:
in response to a setting operation triggered by a user, obtaining a reference range corresponding to a sequence verification set for a first cell, the reference range comprising one or more cells;
obtaining a color corresponding to each cell in the reference range;
in response to an input operation triggered by the user, obtaining target data input by the user in the first cell;
in response to the target data matching data in a second cell in the reference range, rendering the target data in the first cell according to a color corresponding to the second cell, the second cell being any cell in the reference range.
